(19) United States
(12) Patent Application Publication
(10) Pub. No.: US 2006/0026045 A1
(43) Pub. Date: Feb. 2, 2006

(54) Method for providing an income for, or a financial benefit to an individual who loses any or all income, or loses the potential for any or all income, resulting from the necessary and/or voluntary care of another individual who is ill, injured, disabled, diseased, or otherwise incapacitated

(76) Inventor: Jesse Benedict Rothschild, St. Francisville, LA (US)

Correspondence Address: Jesse Benedict Rothschild, 10441 Jacock Rd., St. Francisville, LA, 70775, US

(21) Appl. No.: 10/909,672

(22) Filed: Aug. 2, 2004

(51) Int. Cl. G06Q 40/00

(52) U.S. Cl. 705/4

(57) ABSTRACT

A method for providing an income for, or a financial benefit to an individual who loses any or all income, or loses the potential for any or all income, resulting from the necessary and/or voluntary care of another individual who is ill, injured, disabled, diseased, or otherwise incapacitated; with an insurance policy or other financial instrument, a set of criteria by which an individual may qualify for the insurance policy or financial instrument, a set of criteria used to determine the amount of the fee or premium, a set of criteria used to determine if and when the insured will be eligible for the financial benefit, a fee or premium to be paid by, or for the benefit of, the beneficiary of the insurance policy or financial instrument, and a financial benefit to be paid to the beneficiary of the insurance policy or financial instrument.

### CROSS REFERENCE TO RELATED APPLICATIONS

Not Applicable

### STATEMENT REGARDING FEDERALLY SPONSORED RESEARCH OR DEVELOPMENT

Not Applicable

Description of Attached Appendix

Not Applicable

### BACKGROUND OF THE INVENTION

This invention relates generally to the field of insurance and investment, and more specifically to a method for providing an income for, or a financial benefit to an individual who loses any or all income, or loses the potential for any or all income, resulting from the necessary and/or voluntary care of another individual who is ill, injured, disabled, diseased, or otherwise incapacitated.

There exist insurance policies that pay a financial benefit in the event the beneficiary of the policy becomes ill, injured, disabled, diseased, or otherwise incapacitated. These insurance policies and financial instruments include, but are not limited to: major medical insurance, health insurance, accident insurance, disability insurance, health savings plans, and principal partner insurance. However, none of the existing insurance policies or financial instruments pay an income or financial benefit to an individual specifically for the purpose of allowing that individual the financial wherewithal to care for a different individual in the event that different individual becomes ill, injured, disabled, diseased, or otherwise incapacitated. Most particularly, with the enacting of The Family and Medical Leave Act of 1993, qualified individuals may leave their employment for the purpose, among others, of caring for another individual for up to twelve work-weeks in a 52 week period, and be assured a work position upon return to work; but this leave is typically un-paid. Currently, there are no commercial insurance products, or other commercially available financial instruments, that provide an income during the time an individual is unable to earn an income, or unable to earn a full income, or unable to pursue the ability to earn an income, resulting from the necessary and/or voluntary care of another individual.

### BRIEF SUMMARY OF THE INVENTION

The primary object of the invention is to provide a financial benefit to an individual in the event or events of loss of any or all income, or in the event or events of loss of the potential for income, resulting from the necessary and/or voluntary care of another individual who is ill, injured, disabled, diseased, or otherwise incapacitated.

Another object of the invention is to provide a financial benefit to an individual that allows the individual to care for an ill, injured, disabled, diseased, or otherwise incapacitated individual without the necessity of earning an income, or pursuing the means to earn an income.

Another object of the invention is to provide a financial benefit to an individual that allows the individual to avoid hiring or enlisting another individual or individuals to care for the ill, injured, disabled, diseased, or otherwise incapacitated individual.

A further object of the invention is to provide a financial benefit to an individual that allows the individual to avoid the use of hospitals, nursing homes, primary care facilities, or other institutions for the care of an ill, injured, disabled, diseased, or otherwise incapacitated individual.

Other objects and advantages of the present invention will become apparent from the following descriptions. An embodiment of the present invention is disclosed.

In accordance with a preferred embodiment of the invention, there is disclosed a method for providing an income for, or a financial benefit to an individual who loses any or all income, or loses the potential for any or all income, resulting from the necessary and/or voluntary care of another individual who is ill, injured, disabled, diseased, or otherwise incapacitated, comprising: an insurance policy or other financial instrument; a set of criteria by which an individual may qualify for the insurance policy or financial instrument; a set of criteria used to determine the amount of the fee or premium; a set of criteria used to determine if and when the insured will be eligible for the financial benefit; a fee or premium to be paid by, or for the benefit of, the beneficiary of the insurance policy or financial instrument; a financial benefit to be paid to the beneficiary of the insurance policy or financial instrument.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In accordance with a preferred embodiment of the invention, there is disclosed a method for providing an income or financial benefit to an individual who loses any or all income, or loses the potential for any or all income, resulting from the necessary and/or voluntary care of another individual who is ill, injured, disabled, diseased, or otherwise incapacitated.

This method comprises: an insurance policy or other financial instrument; a set of criteria by which an individual may qualify for the insurance policy or financial instrument; a fee or premium to be paid by, or for the benefit of, the beneficiary of the insurance policy or financial instrument; a financial benefit to be paid to the beneficiary of the insurance policy or financial instrument; a set of criteria used to determine the amount of the fee or premium; a set of criteria used to determine if and when the insured will be eligible for the financial benefit.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A method for providing an income for, or a financial benefit to an individual who loses any or all income, or loses the potential for any or all income, resulting from the necessary and/or voluntary care of another individual who is ill, injured, disabled, diseased, or otherwise incapacitated; comprising:
an insurance policy or other financial instrument
a set of criteria by which an individual may qualify for the insurance policy or financial instrument
a set of criteria used to determine the amount of the fee or premium
a set of criteria used to determine if and when the insured will be eligible for the financial benefit
a fee or premium to be paid by, or for the benefit of, the beneficiary of the insurance policy or financial instrument
a financial benefit to be paid to the beneficiary of the insurance policy or financial instrument
